(19) United States
(12) Patent Application Publication
(10) Pub. No.: US 2008/0297472 A1
(43) Pub. Date: Dec. 4, 2008

(54) COMBINED EXTREME CONCENTRICITY CAPABLE CAMERA-BASED POINTING DEVICE AND A METHOD OF USING IT

(76) Inventor: MARCIN ADAM STEGAWSKI, LAKE OSWEGO, OR (US)

Correspondence Address: MARCIN A STEGAWSKI, 5 ERASMUS ST, LAKE OSWEGO, OR, 97035, US

(21) Appl. No.: 12/127,821

(22) Filed: May 28, 2008

Related U.S. Application Data
(60) Provisional application No. 60/940,448, filed on May 28, 2007.

(51) Int. Cl. G06F 3/033

(52) U.S. Cl. 345/157

(57) ABSTRACT

Contrary to the prior art it has been discovered that in order to build a perfectly concentric camera-based pointing device it is not necessary to make concentric all components of the pointing device itself. Instead, it is possible to rely on an axial symmetry created by rotation of the machine on which the pointing device is used or on an axial symmetry created by rotating the pointing device itself in a manner concentric with any axis of interest on the machine on which the pointing device is used. A combination of an extremely concentric camera shank and a fast-converging center-of-rotation pointer position-adjustment method is the core of the present invention and allows manufacturing of camera-based pointing devices that are low cost, maintain concentricity for the lifetime of the tool, and do not rely on high quality optics or image sensors to deliver extreme pointing ability.

### CROSS-REFERENCE TO RELATED APPLICATIONS

This application claims the benefit of the Provisional Application No. 60/940,448 filed on May 28, 2007.

### STATEMENT REGARDING FEDERALLY SPONSORED RESEARCH OR DEVELOPMENT

The present invention was not made under federally sponsored research or development.

### FIELD OF THE INVENTION

The invention relates to non-contact camera-based pointing devices with application in machining, on-machine inspection, and reverse engineering.

### BACKGROUND OF THE INVENTION

Aligning the axis of rotation or the axis of symmetry of a machine with a point on a target is needed, among others, for machining, on-machine inspection, and reverse engineering. One important application in machining is providing a reference point(s) on the surface of a workpiece for a CNC machine.

Camera-based pointing devices are well known and widely used. The usual and obvious way to build them is to concentrically align all components of a pointing device, such as the shank, the image sensor, the lens, and a cross-hair or other form of pointing insignia in the view. The pointing insignia can be added electronically as an overlay to the image from the camera. One example of the previous art in pointing devices can be found in U.S. Pat. No. 6,647,840 B2, Nov. 18, 2003. The common problem in all known solutions is the high cost of building a pointing device that is almost perfectly concentric. It becomes even more challenging if a variable focus lens is to be used because not just the lens itself must be concentric but also it has to be mounted and rotate concentrically. Maintaining concentricity for the life span of the tool and resistance to accidental shocks and vibrations are also a problem making the known camera-based pointing devices delicate and fragile instruments.

Contrary to the prior art it has been discovered by the Applicant that in order to build a perfectly concentric camera-based pointing device it is not necessary to make concentric all components of the pointing device itself. Instead, it is possible to rely on an axial symmetry created by rotation of the machine on which the pointing device is used or on an axial symmetry created by rotating the pointing device itself in a manner concentric with any axis of interest on the machine on which it is used. For the pointing device itself it is sufficient to have a highly concentric shank and a rigid design that will maintain all pointing device components at fixed locations in reference to the shank. Concentricity of the shank is required to achieve repeatable insertion into the machine or ability to precisely rotate the pointing device in reference to the machine. The image generated by the pointing device can be free from any pointing insignia. A freely user-adjustable on-screen pointer and a pointer alignment method will be needed to mark the location of the center of the rotation as observed on the screen. The pointer can be added as an overlay to the said image. One example of such a pointer can be the usual on-screen pointer used in computer systems based on Windows® by Microsoft Corporation or Macintosh® computers manufactured by Apple Computer Corporation. A readjustment of the on-screen pointer will be needed each time the geometry of the pointing device components changes, e.g., a change of focus. A fast converging method has been discovered that makes the pointer position adjustment possible. The method works in the presence of optical distortions and is highly tolerant of inexact 180 degree rotation that is required in the process of adjusting the pointer location. It is the combination of the highly concentric camera shank and the pointer adjustment method that makes a low cost extreme precision camera-based pointing device possible and constitutes the core of the present invention.

### BRIEF SUMMARY OF THE INVENTION

It was observed and consequently discovered, that in order to build a perfectly concentric camera-based pointing device, contrary to the previous art, there is no need to make any of the components of the camera, such as lens or image sensor coaxial with the rotational axis of the machine on which the pointing device is used. All that is needed is: (a) a highly concentric shank creating a concentric interface with the machine and (b) an on-screen pointer position adjustment method that would exhibit fast convergence to the on-screen image of the point at the intersection between the axis of rotation of the machine and the surface of a workpiece or a target. Ability of the pointing device to concentrically rotate along the axis of rotation, or the axis of symmetry, or any axis of interest on the machine on which the pointing device is used is assumed. This can be facilitated by a spindle or, in the simplest implementation, a calibrated bore.

The present invention yields pointing devices of potentially zero error, devices that can be manufactured at low cost, maintain concentricity for the lifetime of the tool, and do not rely on high quality optics or image sensors to deliver extreme concentricity.

The description of the invention shows how to make and use a pointing device capable of extreme concentricity. As result of close to perfect concentricity and known maximum errors the pointing device built and used per the present invention can be used to calibrate other types of pointing devices, such as but not limited to laser pointers.

### BRIEF DESCRIPTION OF THE SEVERAL VIEWS OF THE DRAWING

FIG. 1 is a view showing the typical environment in which the present invention is used. Here an ideal perfectly concentric pointing device is shown mounted in a toolholder and spindle of the machine on which the device is used, the link to an electronic processing unit such as a personal computer, the electronic processing unit, and the graphical display driven by the electronic processing unit.

FIG. 2 is a view showing a real pointing device built per present invention with components and their axis of rotation that may or may not be aligned with the axis of rotation of the machine's spindle.

FIG. 3 is a view showing the circle at which the real device points at as the machine's spindle is rotated. It is the result of a superposition of the misalignments as already shown in FIG. 2.

FIG. 4a is a view showing a light beam forming an image of the point on the target that is aligned with the axis of rotation of a machine on which the pointing device is used. The image is projected on the surface of the image sensor.

FIG. 4b is a view similar to FIG. 4a showing the image formation when the spindle of the machine is rotated by 180 degrees. Note that thanks to axial symmetry the position on the image sensor of the image of the point on the target that is aligned with the axis of rotation does not change with rotation.

FIG. 5a is a view showing the graphical display with the image of the point on the target with camera aligned to 0 degrees and when there is no alignment between the point on the target and the axis of rotation.

FIG. 5b is a view similar to FIG. 5a but showing the graphical display with the image of the point on the target with camera aligned to 180 degrees.

FIG. 5c is a view showing the superposition of views in FIG. 5a and FIG. 5b when the point on the target is not aligned with the axis of rotation. Rotating the camera results in a shift of the image.

FIG. 6a is a view showing the first step in the alignment procedure. Camera at zero degrees.

FIG. 6b is a view showing the second step in the alignment procedure. Camera at 180 degrees.

FIG. 6c is a view showing the first step of the alignment procedure as seen on the display screen.

FIG. 6d is a view showing the second step of the alignment procedure as seen on the display screen. Pointer is moved to the half-error position.

FIG. 6e is a view showing the alternative second step of the alignment procedure as seen on the display screen. Point moves to the half-error position.

FIG. 6f is a view showing the final step of the alignment procedure as seen on the display screen.

FIG. 7 is a view showing flow diagram of the alignment procedure.

### DETAILED DESCRIPTION OF THE INVENTION

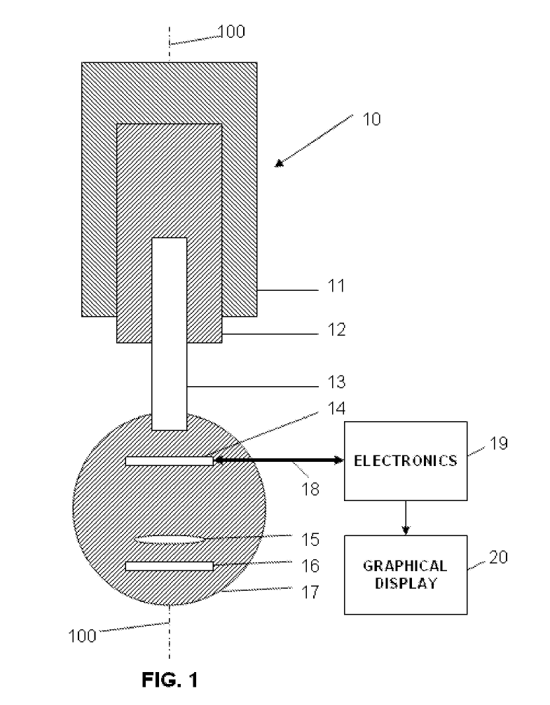

FIG. 1 shows the usual way a pointing device is built and used. A pointing assembly 10 is comprised of a machine's spindle 11, a toolholder 12, and a pointing device placed in the toolholder using a shank 13. The said shank is usually an integral part of the pointing device. The pointing device is comprised of the said shank, an image sensor subsystem 14, lens 15, and optional pointing insignia 16 such as crosshairs. Enclosure 17 holds all parts of the pointing device together and must provide a sufficient rigidity to maintain the required pointing precision. A communication link 18 is used to deliver the image from the image sensor subsystem to the electronic processing unit called here “Electronics” 19. The communication link can by physical, e.g., comprised of wires or optical fibers, or wireless, e.g., infrared or radio. The image sensor subsystem can be of any level of integration with the image processing electronics. One example of a highly integrated image sensor is the PAC207 CMOS image sensor by Pixart, Taiwan. The PAC207 combines on a single silicone chip a CMOS image sensor, image compression hardware, and a USB computer interface controller. In the case of the PAC207 the Electronics block 19 is just a standard personal computer or a laptop. The Graphical Display 20 can be integrated with the electronics, as is the case with laptops, but usually is a separate unit connected to the Electronics block. The Electronics block does not have to be based on a computer. It could be a programmable logic device such as an FPGA. In general the functionality of the Electronics block can be defined in hardware or in a mixture of hardware and software and can include any signal conditioning analog circuitry as needed. The image sensor can be either faceted, i.e., pixelized, or continuous. Pixelized sensors have the advantage of knowing the limits of image positional and size errors, i.e., ½a pixel. Also, the errors remain fixed for the life of the sensor. Analog continuous sensors have the advantage of virtually infinite resolution that may result in an overall zero concentricity error for the pointing device but, usually, the analog image processing adds both positional and size errors and the limits of error may not be well defined or known and can change over time.

The designer and the manufacturer of a pointing device shown in FIG. 1 is highly concerned with making all parts of the pointing device concentrically aligned with the axis of rotation 100 of a machine on which the pointing device is used. An example of this effort and concern can be seen in U.S. Pat. No. 6,647,840 B2, Nov. 18, 2003.

Continuing with FIG. 1, the interface between the pointing device and the machine on which it is used does not have to be comprised of a spindle 11 and a toolholder 12, i.e., the rotation of the pointing device does not have to be facilitated by a spindle and/or a toolholder. The pointing device can interface directly with a bore coaxial with the axis of symmetry or any axis of interest such as is the case with gun barrels and pointing equipment used in triangulation for surveying and navigation. For the pointing device per present invention it is essential that the pointing device could be rotated by at least 180 degrees in the axis of interest.

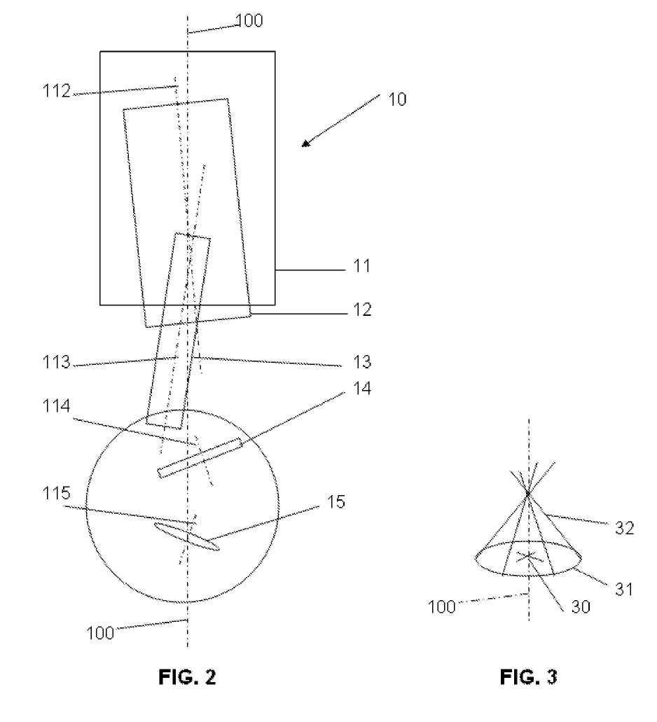

FIG. 2 shows, in an exaggerated way, that in reality the axes of symmetry 112, 113, 114, and 115 of all components of a pointing assembly 10, i.e., 12, 13, 14, 15 are not perfectly concentric with the axis of rotation or axis of interest 100 of a machine on which the pointing device is used. For simplicity, it is assumed here that the pointing assembly rotates perfectly along the axis 100. In actual implementations or due to the wear of bearings the spindle can rotate along a slightly different axis than 100. A superposition of all of the misalignments results in the pointing device pointing at an angle to the axis 100 as shown in FIG. 3, item 32. When the pointing assembly rotates along the axis 100 the pointing device actually points at points belonging to an ellipse 31 and not at the center 30 that is the crossing point of the axis of rotation and the surface of a target or a workpiece. It is assumed here that the depth of focus of the pointing device includes the ellipse 31 on the surface of a target or a workpiece. The ellipse becomes a circle when the surface of the workpiece or target is perpendicular to the axis 100 and planar. Despite the best efforts of designers and manufactures of known pointing devices, to a certain extent, the situation as described in FIG. 2 and FIG. 3 is always the case as it is impossible to build and maintain a perfectly concentric pointing device.

Contrary to the previous art, the Applicant has discovered that it is possible to build a pointing device capable of extreme concentricity without making all parts of the device concentric. Instead of making an attempt to make all parts concentric, it is possible to rely solely on the axial symmetry created by the rotation of the machine on which the pointing device is used or on an axial symmetry created by rotating the pointing device itself in a manner concentric with the axis of symmetry or any axis of interest on the machine on which the pointing device is used. To be able to rely on the rotational symmetry the interface to the machine has to be as perfectly concentric as possible. One embodiment of such an interface is a known class, NIST traceable round plug gage used as a shank for the pointing device. For example an X class plug gage has a maximum runout of only 40 microinches. A typical precision used in the industry is 0.001 inch, i.e., the runout is 50 times lower. Plug gages of even higher than X class are readily available and relatively inexpensive.

In the present invention the camera-based pointing device has to meet two requirements: (1) extreme concentricity of the interface to the machine, i.e., the shank and (2) that the axis of symmetry of the shank intersects with the camera's sensor within the optically active area of the sensor. The second requirement is so easy to meet that it is mentioned here only to achieve completeness of the invention's description. Based on the present invention it is thus possible to manufacture pointing devices at a very low cost and with a lifetime performance guarantee, i.e., until the precision shank wears off and the device looses the capability to interface in a concentric manner with the machine on which it is used.

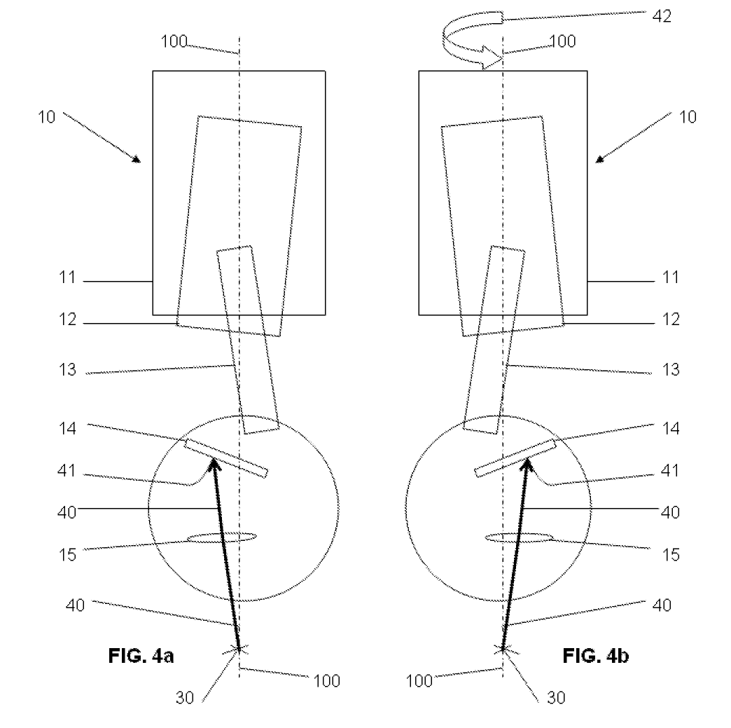

FIG. 4a shows a ray of light 40 creating an image 41 of the target point 30 on the surface of the image sensor 14. The target point 30 is at the intersection of the axis of rotation of the machine or any axis of interest along which the pointing device itself is rotated. The point 30 is the point at which an ideally concentric pointing device would point. Due to the axial symmetry created by rotation along the axis 100 the position of the image 41 on the surface of the image sensor 14 does not change as the pointing assembly is rotated along the axis 100.

FIG. 4b shows the situation after the pointing assembly 10 has been rotated by 180 degrees as shown by the arrow 42. As explained earlier in the absence of a spindle 11 and/or the toolholder 12 the pointing device itself, i.e., its shank could be rotated along the axis of rotation 100 with the same result.

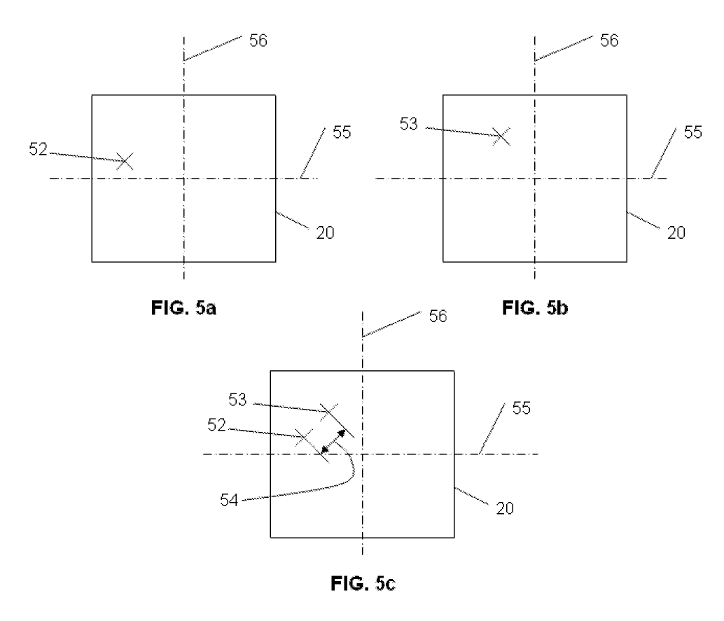

If the target point 30 is not aligned with the axis of rotation the image of the target point would no longer remain at a fixed position on the surface of the image sensor when the pointing device is rotated. FIG. 5a shows an example of the view of the image of the target 52 on the display monitor 20 at some initial position of the pointing assembly, say 0 degrees. For reference the axes of symmetry of the display unit are shown as 55 and 56, 55 being horizontal or X and 56 being vertical or Y axis. FIG. 5b shows an example of a different position of the view of the image 53 after the pointing assembly was rotated by 180 degrees. FIG. 5c summarizes the shift in image position 54. Since the optics and the position of the sensor subsystem are not aligned with the axis of rotation the image of the target 30 is unlikely to be at the center of the display and will move during the rotation.

The objective of the alignment method is to align the target point with the axis of rotation and to mark the position of the view of the image of the target on the display 20 as the center point of rotation as observed on the display. Both the target and the on-screen pointer have to be moved in order to accomplish the alignment. The target point can be moved in the camera view by moving the table holding the workpiece on the machine. If a computer is used for displaying the image from the camera used in the pointing device the on-screen pointer can be easily moved using a mouse, or a touchpad, or other pointer positioning input device. If a specialized system is used for displaying the image it has to provide means for marking a specific position on the screen either by using a pointer such as but not limited to a crosshairs or by changing attributes of the point on the display such as, but not limited to, the color or the brightness of a point, or making it blink.

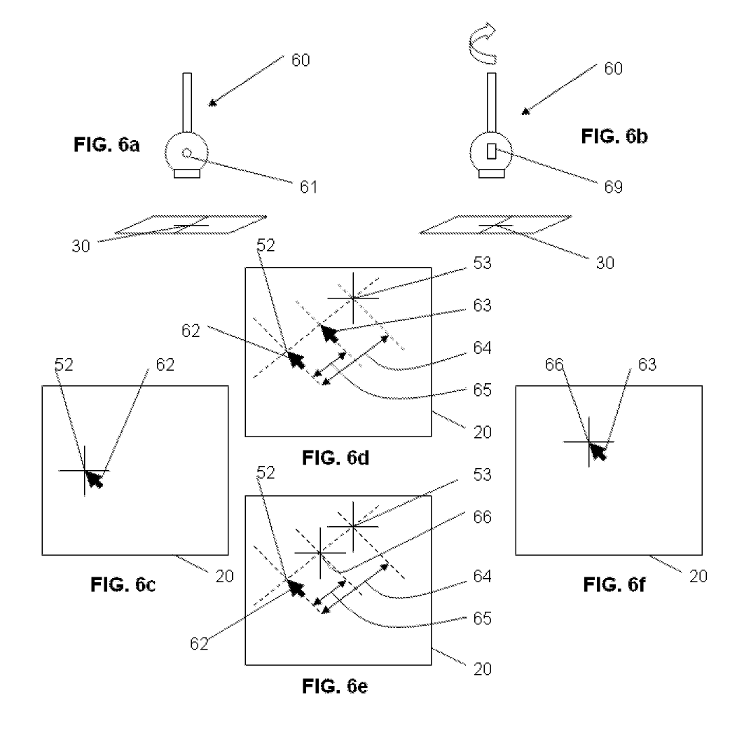

Since the alignment method relies on rotating the pointing assembly or the pointing device itself by 180 degrees it helps to have marks on the body of the pointing device to show zero, item 61 in FIG. 6a, and 180 degrees position, item 69 in FIG. 6b. In one of the possible embodiments of the present invention the two positions, 0 and 180 degrees, could be achieved using motorized means allowing a fully automated alignment procedure. It needs to be emphasized that the exact value of 180 degrees is non-critical for the convergence of the alignment method.

FIG. 6c shows the view of the image of the target point 52 on the display 20 when the pointing device is at 0 degree position. The on-screen pointer 62 has been moved to the same position. This creates the initial state in the alignment procedure. The user rotates the pointing device or its assembly to the 180 degree position. If the pointing device and/or the target are misaligned the image of the target point 53 shifts to a new location on screen. Now, the user has a choice to either make an adjustment of the on-screen pointer position 62, FIG. 6d, or shift the target point position, 53, FIG. 6e. In both cases the objective is to shift the pointer or the image of the target respectively to error 65 position where the error 64 refers to the distance between positions 52 and 53. The user follows with rotating the pointing device to the zero position and either moving the target 66 or the on-screen pointer 63 to fully aligned position, FIG. 6f.

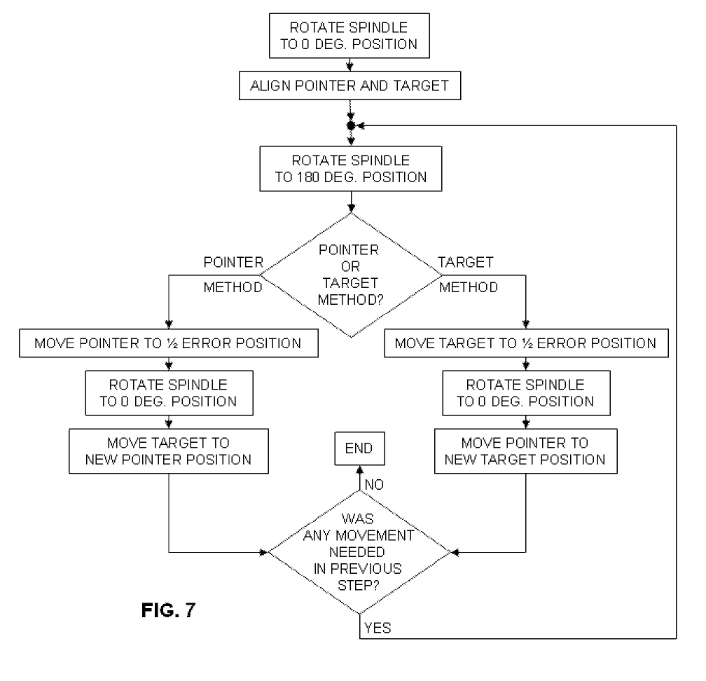

FIG. 7 summarizes the alignment method and the alignment procedure assuming that the pointing device is placed in a toolholder 12 that is placed in a machine's spindle 11. Replacing the word “spindle” with “pointing device” makes FIG. 7 applicable to cases when there is no spindle and/or toolholder and the pointing device is rotated directly. FIG. 7 shows clearly the steps for both the pointer-oriented method and the target-oriented method. The choice of method version depends on what is easier to do and/or what can be done more precisely to reach the ½ error position. On machines with digital position readout shifting the target point can be usually accomplished with higher precision than moving the on-screen pointer.

If the rotation used during the alignment procedure was exactly 180 degrees and the camera had no optical distortions the final alignment shown in FIG. 6f could be reached in one step. Since one or both conditions are usually not met the adjustment procedure has to be repeated until no correction is needed anymore. With image sensors that are faceted or pixelized the alignment ends when the error is within ½ pixel size. With sensors that are analog and continuous the alignment can lead to zero error. This is why the combined extreme concentricity capable camera-based pointing device and the method of using it as described here can be considered a reference method and used to calibrate other pointing devices.

Since the main objective behind the present invention was to build low-cost but precise pointing devices the preferred embodiment of the present invention is the simplest possible—a low cost camera placed on an extremely concentric shank combined with the pointer-based on-screen pointer position alignment method as this version of the method does not require any position readout for the machine's table, i.e., can be used on any machine.

Lexicographic definition: extremely concentric shank is a camera shank exhibiting a radial symmetry that has a runout at least an order of magnitude smaller than either the resolution of the camera sensor mounted on the said shank or the required concentricity of the pointing device in case the required concentricity is less restrictive than the sensor's resolution.

I claim:

1. A pointing apparatus for machining, on-machine inspection, and reverse engineering comprising:
a pointing device, said pointing device comprising:
an extremely concentric shank,
a camera mounted on the said shank in a manner that is not necessarily fully concentric with the shank but guarantees that the axis of symmetry of the said shank intersects with the camera's image sensor within the optically active area of the camera's image sensor;
a display showing the images from the said camera, said display having an on-screen pointer that:
can be freely moved by the user to the point on the display that is the observed center of rotation of the pointing device on the said display, and
is moved towards the observed center of rotation according to any on-screen pointer position adjustment procedure that uses two angular positions of the pointing device that differ by exactly or approximately 180 degrees.

2. A pointing apparatus as set forth in claim 1 that uses an industry Z, X or higher precision class plug gage as the extremely concentric shank.

3. A pointing apparatus as set forth in claim 1 that uses one of the industry standard machine collets as the extremely concentric shank.

4. A pointing apparatus as set forth in claim 1 that uses internal motorized means to achieve a rotation of the pointing device by 180 degrees as needed for the on-screen pointer adjustment procedure.
